(19) United States
(12) Patent Application Publication
(10) Pub. No.: US 2010/0115290 A1
(43) Pub. Date: May 6, 2010

(54) KEYBOARD AND METHOD FOR SECURE TRANSMISSION OF DATA

(76) Inventors: Reiner Walch, Muennerstadt (DE); Bernd Grossmann, Oberstreu (DE)

Correspondence Address: Muncy, Geissler, Olds & Lowe, PLLC, P.O. BOX 1364, FAIRFAX, VA, 22038-1364, US

(21) Appl. No.: 12/613,220

(22) Filed: Nov. 5, 2009

Related U.S. Application Data
(60) Provisional application No. 61/233,637, filed on Aug. 13, 2009.

(30) Foreign Application Priority Data
Nov. 5, 2008 (DE) DE102008055991.1

(51) Int. Cl. G06F 12/14; H04L 9/28

(52) U.S. Cl. 713/190; 705/71

(57) ABSTRACT

A keyboard, in particular a POS (point of sale, point of service) keyboard, bank keyboard, keyboard for secure data entry, and a method for secure transmission of data that is entered through various data entry modules such as, e.g., magnetic card readers, chip card readers, key switches, or a keypad, to an external device connected to the keyboard, for example a computer. The keyboard comprises at least one data entry module for entering data and a keyboard control device with at least one receiving device for receiving the entered data, an encryption device for encrypting the received data by means of an encryption algorithm, wherein the encryption algorithm is present in the form of program code, and a transmission device for transmitting the data encrypted by the encryption means to the external device connected to the keyboard control device, wherein the encryption algorithm can be selected by the user from multiple predefined encryption algorithms and associated with the data entry module.

This nonprovisional application claims priority to German Patent Application No. 10 2008 055 991.1, which was filed in Germany on Nov. 5, 2008, and to U.S. Provisional Application No. 61/233,637, which was filed on Aug. 13, 2009, and which are both herein incorporated by reference.

### BACKGROUND OF THE INVENTION

1. Field of the Invention

The invention relates to a keyboard, for example, a POS (point of sale, point of service) keyboard, bank keyboard, keyboard for secure data entry, and a method for secure transmission of data that is entered through various data entry modules such as, e.g., magnetic card readers, chip card readers, key switches or a keypad, to an external device connected to the keyboard, for example a computer.

2. Description of the Background Art

The secure transmission to an external device of data that is entered through a keyboard has increasingly been the focus of new developments in recent years. Especially when keyboards are used in electronic cash register systems in banks or in POS terminals for carrying out cashless payment processes at a point of sale, or in online banking transactions, for example over the Internet, the protection of the data entered through the keyboard from unauthorized access by third parties is of paramount importance. While all banks and most e-shops offer secure data transmission via encryption protocols, even a secure network connection does not protect from monitoring of the data by Trojans or what are known as keyloggers. Keyloggers are programs or devices that secretly record all keypresses and transmit them to a third party for subsequent analysis. Keyloggers are capable of bypassing password-protected encryption systems in that they monitor the desired information prior to the encryption. Keyloggers can reach the computer as programs that are manually installed or can be introduced into the computer system by means of a virus that is received through a network such as the Internet or an intranet, for example. As hardware, simply connecting a small device between the keyboard and the computer. Moreover, when wireless keyboards are used, it is not even necessary to have physical access to a computer, since in principle it is possible to eavesdrop on the data within the transmission range of the wireless keyboard.

To attain the object described above, US Publication No. 2007/0143593 A1 discloses a secure input device and a secure input method for protecting data that are transferred between an input device, for example a keyboard, and a destination device, for example a PC. The device has two security modules (hardware), of which one is integrated in the keyboard and the other is attached to a computer. The first security module receives data that are to be transmitted to the PC by the keyboard, and then processes the received data to produce a protected, which is to say encrypted, data output. A second security module receives the protected data from the first security module and converts the protected data back into the original form. The reconverted data are then conveyed to the PC by the second security module. The system makes possible a secure communication channel between the keyboard and the PC without requiring additional drivers or software.

Another solution is shown in U.S. Pat. No. 7,366,916 B2, which describes a method and a keyboard for protecting data that are generated by the keyboard. The data are generated by a keypad of the keyboard and are read by a processor. Then the generated data are encrypted by means of an encryption function, and the encrypted data are transmitted by the keyboard to a computer. The encryption routine can be stored in various types of memory, for example ROM, RAM or flash memory. It is possible to change the encryption routine even after production of the keyboard and, for example, before its use, in that, e.g., programmable read-only memory is used to store the encryption routine.

### SUMMARY OF THE INVENTION

It is therefore an object of the present invention to provide a keyboard for the secure transmission of data from all data entry modules belonging to a keyboard, such as keypads, magnetic card readers, chip card readers, and key switches, to an external device connected to the keyboard.

In addition, it is an object of the invention to provide a method for encryption of data from all data entry modules belonging to a keyboard, such as keypads, magnetic card readers, chip card readers, and key switches, to an external device connected to the keyboard.

In an embodiment, the invention is based on the concept of encrypting data, which are entered through various data entry modules connected to the keyboard, by an encryption device of a keyboard control device, before they are transmitted to an external device connected to the keyboard. In this regard, the user can separately associate a different user-selectable encryption algorithm with each data entry module. The data from the various data entry modules can also be encrypted with a single encryption algorithm. Moreover, one and the same encryption algorithm can be defined by the user for the entire keyboard. Furthermore, the encryption for each data entry module is separately activatable and deactivatable by the user, or can be briefly activated and/or deactivated for security-relevant entries.

The data input modules connected to the keyboard control device always transmit their data to the keyboard control device in unencrypted form. The encryption thus is accomplished in a central location by the keyboard control device before it outputs the encrypted data to an external device connected to the keyboard. This has the advantage that conventional and commercially available standard data entry modules may be used, which consequently do not have to be designed to encrypt the data. As a result, the manufacturing costs and the development costs of such a keyboard are reduced considerably, and the keyboard can be adapted to the particular requirements of the application easily and flexibly through configuration by the user. Nevertheless secure transmission to an external device of the data entered through the data entry modules is always ensured. The data are already encrypted before a third party can intercept and steal them.

The use of conventional, commercially available standard data entry modules makes it possible, firstly, to reduce the manufacturing costs of the inventive keyboard as compared to such keyboards that depend on the use of special, and hence expensive, data entry modules or other expensive special hardware. Secondly, the development costs for the inventive keyboard can be reduced considerably by the use of standard entry modules, since standard entry modules have been known for a long time and are extremely likely to be available on the market in great numbers even in future. As a result, adaptations to special modules with, e.g., proprietary data protocols are avoided.

Furthermore, the inventive keyboard achieves very great flexibility through the use of the standard entry modules, which is of great advantage in adapting to the requirements of the application in question. The desired data entry modules can be selected from a plethora of standard entry modules available on the market, and integrated in the inventive keyboard. Moreover, the user can later flexibly configure the encryption functions of the inventive keyboard, since there are no limitations resulting from encryption functions permanently integrated in the special modules.

Since the encryption algorithms can be selected by the user and are not predetermined by the data input modules integrated in the keyboard, the encryption effort can also be reduced as a function of the requirements of the application. A uniform encryption of all data entry modules is possible, for example. Furthermore, the specific association of an encryption algorithm with a data entry module allows optimal adaptation of the encryption algorithm to the characteristic data stream generated by a data entry module. Consequently, it is possible to reduce the total encryption effort for all data entry modules.

The term “external device” means any device that the keyboard can be connected to. It could be a completely separate device in a separate housing, for example, such as a personal computer. However, it could also be a device into which the keyboard is integrated as an assembly, for example an electronic cash register, a POS terminal, or a central computer in a bank.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exploded view to illustrate the structure of an embodiment of a keyboard,

FIG. 2 is a block diagram to illustrate a first association between the entered data from various data entry modules of the embodiment of the inventive keyboard shown in FIG. 1, an encryption algorithm used for the encryption, and the data output by the inventive keyboard,

FIG. 3 is a block diagram to illustrate a second association between the entered data from various data entry modules of the embodiment of the inventive keyboard shown in FIG. 1, multiple encryption algorithms used for the encryption, and the data output by the inventive keyboard, and

FIG. 4 is a block diagram to illustrate a third association between the entered data from various data entry modules of the embodiment of the inventive keyboard shown in FIG. 1, an encryption algorithm used for the encryption, and the data output by the inventive keyboard.

### DETAILED DESCRIPTION

All components of the keyboard according to the present invention that are not essential to the invention are not shown in the drawings for the sake of simplicity.

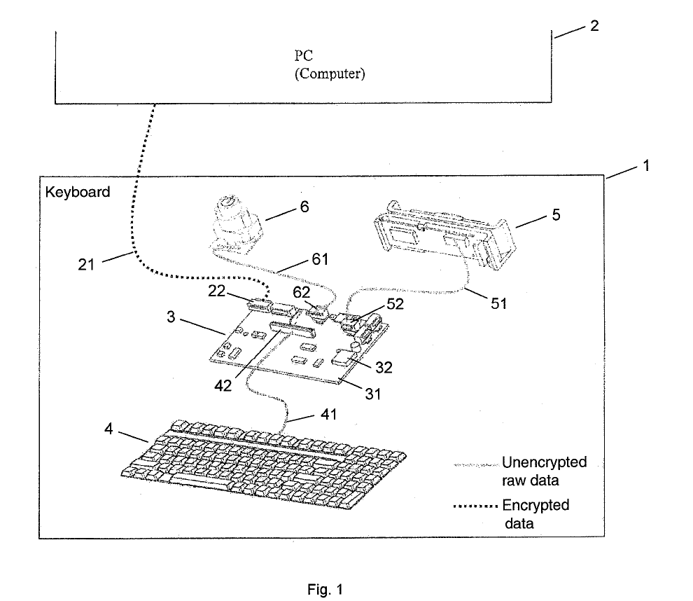

FIG. 1 represents an exploded view of the structure of an embodiment of the inventive keyboard. A housing or the like, in which the keyboard 1 is typically placed with its components described below, is not shown in FIG. 1. Housings to accommodate the keyboard 1 according to the present invention are generally known to those skilled in the art.

The keyboard 1 includes a keyboard control device 3 and one or more data entry modules 4, 5 and 6. The data entry modules 4, 5 and 6 are connected to the keyboard control device 3 by appropriate data transmission connections 41, 51 and 61. The keyboard control device 3 is comprised of a circuit board 31, on which various electronic components, such as microprocessors, working memory (RAM), read-only memory (ROM), and/or programmable read-only memory (for example, EEPROM or flash PROM), etc., are arranged and connected to one another in order to be able to implement conventional keyboard functions including processing of the data entered via the data entry modules 4, 5 and 6 as well as the transmission of these data to an external device 2. The control of these keyboard functions is generally implemented through a software program that is executed in the keyboard control device 3. Rather than being shown in detail in FIG. 1, the various electronic components are indicated schematically, since the general structure of such an electronic keyboard controller, such as is also used in the embodiment of the present invention, is generally known from the prior art. For this reason, a detailed description of the electronic structure of the rest of the electronic keyboard controller is omitted below.

Also arranged on the keyboard control device 3 are various module interfaces 42, 52 and 62. The data transmission connections 41, 51 and 61 of the corresponding data entry modules 4, 5 and 6 are connected to the associated module interfaces 42, 52 and 62. In addition, the keyboard control device 3 includes a keyboard interface 22, with which the external device 2 is connected through a data transmission connection 21. It should be noted that the data transmission connection 21 shown in FIG. 1 is not restricted to a wired connection, but rather also includes wireless transmission methods, such as are generally known to those skilled in the art, between the keyboard 1 and the external device 2.

The data entry modules 4, 5 and 6 are used for the entry of data. Shown as data entry modules in FIG. 1 by way of example are a keypad 4, a magnetic card reader 5, and a key switch 6. The magnetic card reader 5 and the key switch 6 are optional data entry modules. Optional data entry modules are not strictly necessary for implementing the inventive keyboard and can be integrated as desired and in various combinations in the keyboard 1, depending on the requirements for the application. Other possible optional data entry modules for connection to the keyboard control device 3 in addition to the data entry modules shown in FIG. 1 could be, for example, chip card readers, special keypads (e.g., PIN pads or numeric keypads), barcode scanners, USB devices, and other data entry devices generally known to those skilled in the art.

The data entered through the data entry modules 4, 5 and 6 are transmitted in unencrypted form through the appropriate data transmission connections 41, 51 and 61 to the keyboard control device 3. In the keyboard control device 3, appropriate receiving device are provided that receive the data sent through the data transmission connections 41, 51 and 61 at the applicable module interfaces 42, 52 and 62. The data are forwarded by the receiving device to an encryption device provided in the keyboard control device 3. The encryption device may be, for example, a component of the software mentioned above for controlling the keyboard functions. The encryption device encrypts the received data by means of an encryption algorithm 301, 302 or 303. The encryption algorithm 301, 302 or 303 is present in the encryption device in the form of program code. After encryption, the data are sent to a transmission device provided in the keyboard control device 3 that outputs the encrypted data through the keyboard interface 22. These data are then transmitted through the data transmission connection 21 to the external device 2. As a result, secure transmission of all data entered through the data entry modules 4, 5 and 6 to the external device 2 is ensured.

The encryption algorithm used by the keyboard control device 3 can be selected by the user from a plurality of predetermined encryption algorithms 301, 302 and 303. Furthermore, the user can associate an encryption algorithm 301, 302 or 303 separately with each data entry module, which is to say that the data stream generated by the different data entry modules 4, 5 and 6 is encrypted in each case by the associated encryption algorithm 301, 302 or 303. Moreover, the user can activate and deactivate the encryption of the data entry modules 4, 5 and 6 individually. What is more, the encryption can also be activated and/or deactivated in the short term during operation of the keyboard for entries relevant to security. This can be accomplished through a control command from the external device 2, for instance. In like manner, the activation/deactivation can be performed by the user by means of a specially designated key on the keypad, a key combination that can be uniquely identified by the keyboard control device and that is not used during normal entry operations, or by the insertion of a magnetic card or chip card in the appropriate data entry device, or by other manual entries at one of the data entry modules.

Configuration of the keyboard control device 3 by the user is accomplished with a configuration program that is executed on the external device 2 connected to the keyboard.

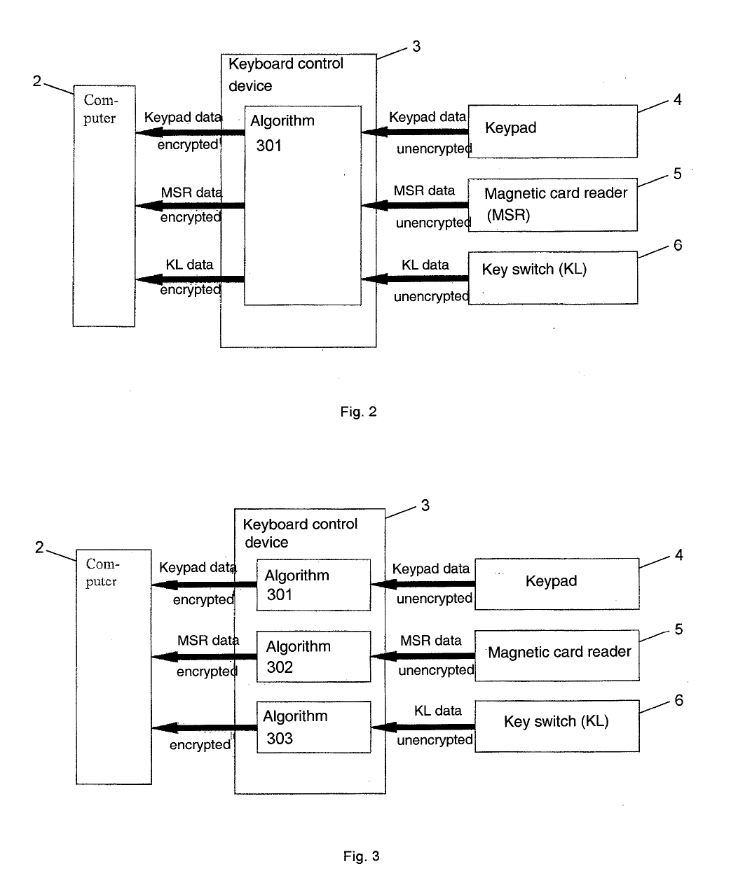

FIGS. 2 through 4 graphically illustrate the individual options for associating the user-selectable encryption algorithms 301, 302 and 303 with the respective data entry modules.

FIG. 2 is a block diagram that illustrates a first association between the entered data from the various data entry modules 4, 5, and 6 of the embodiment of the inventive keyboard shown in FIG. 1, an encryption algorithm 301 used for the encryption, and the data output by the inventive keyboard. As shown in FIG. 2, the data entered through the data entry modules 4, 5, and 6 are transmitted to the keyboard control device 3 in unencrypted form and in separate data streams. The encryption device of the keyboard control device 3 in FIG. 2 is configured such that a single encryption algorithm 301 encrypts all data from the data entry modules 4, 5, and 6. The encrypted data are then transmitted from the keyboard control device 3 to the external device 2 in separate data streams. FIG. 2 shows the case in which the data from each data entry module 4, 5, and 6 are encrypted by a single encryption algorithm 301 and are then transmitted separately to the external device 2.

FIG. 3 is a block diagram that illustrates a second association between the entered data from the various data entry modules 4, 5, and 6 of the embodiment of the inventive keyboard shown in FIG. 1, multiple encryption algorithms 301, 302, and 303 used for the encryption, and the data output by the inventive keyboard. As shown in FIG. 3, the data entered through the data entry modules 4, 5, and 6 are transmitted to the keyboard control device 3 in unencrypted form and in separate data streams. The encryption device of the keyboard control device 3 in FIG. 3 is configured such that different encryption algorithms 301, 302, and 303 are each associated with a data entry module 4, 5, and 6. Consequently, the data from the data entry modules 4, 5, and 6 are encrypted with the corresponding associated encryption algorithms 301, 302, and 303. The encrypted data are then transmitted in separate data streams to the external device 2 by the keyboard control device 3. FIG. 3 thus represents the case in which the data entered from each individual data entry module 4, 5, and 6 are encrypted with different encryption algorithms 301, 302, and 303 and are then transmitted separately to the external device 2.

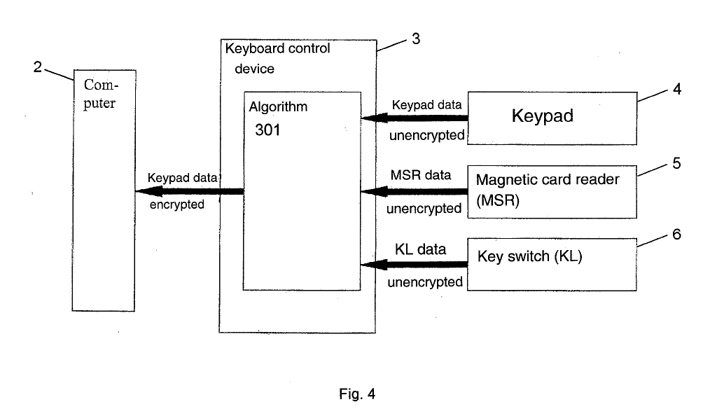

FIG. 4 is a block diagram that illustrates a third association between the entered data from the various data entry modules 4, 5, and 6 of the embodiment of the inventive keyboard shown in FIG. 1, an encryption algorithm 301 used for the encryption, and the data output by the inventive keyboard. As shown in FIG. 2, the data entered through the data entry modules 4, 5, and 6 are transmitted to the keyboard control device 3 in unencrypted form and in separate data streams. The encryption device of the keyboard control device 3 in FIG. 3 is configured such that a single encryption algorithm 301 encrypts all data from the data entry modules 4, 5, and 6. The encrypted data are then transmitted from the keyboard control device 3 to the external device 2 in a common data stream. FIG. 4 thus represents the case in which all of the data of the keyboard 1 is encrypted with a single encryption algorithm 301 and is then transmitted to the external device 2 in a common data stream.

One or more keys are required for encrypting the data entered through the data entry modules 4, 5, and 6 using the encryption algorithms 301, 302, and 303. These keys can be written in the keyboard control device 3 by means of a configuration, and can be stored there on a long-term basis. Moreover, the keys can also be changed during operation of the keyboard 1 by means of an application. Furthermore, it is possible for the keyboard control device 3 to randomly select the key, with an index to a known key table being transmitted to the keyboard control device 3. Furthermore, the keys for the encryption method can also comprise a secret key and a public key. Lastly, it is also possible for the user to enter a key that is subsequently used for the encryption of the data. The above-mentioned individual options with regard to using the key for the encryption can also find application in the inventive keyboard 1 in any desired combination.

Of course, the present invention is not restricted to the example embodiment described above. Thus, for example, the keyboard can also be connected to the external device by means of a wireless technology (for example, a radio connection).

Moreover, individual components, for example data entry modules, can be omitted, or additional electronic components such as LEDs can be added. Of course, additional data entry modules—including several of the same type—beyond those described in the example embodiment explained in FIG. 1 can also be connected to the keyboard control device. Thus, in addition to a keypad, the keyboard can be provided with, e.g., an additional keypad such as a numeric pad (numeric keypad) or a special keypad adapted for the particular area of application, for example a PIN pad. The use of bar code scanners or USB devices as data entry modules, as well as other data entry devices generally known to the practitioner of the art, is also conceivable. Moreover, the inventive keyboard is not limited to having the data entry modules integrated within the keyboard, which is to say inside the keyboard housing. Similarly, the data entry modules could also be externally connected to the keyboard via module interfaces accessible from outside the keyboard housing.

Furthermore, the keyboard can be designed such that the configuration of the keyboard control device is accomplished by means of the configuration program through a network or through the Internet by remote maintenance. In like manner, configuration of the keyboard control device through a data entry module connected to the keyboard, such as a chip card reader, is also possible, wherein the configuration settings would then be contained in a chip card to be introduced into the chip card reader. Likewise, a configuration of the keyboard directly through the keypad of the keyboard is also possible. In this case a display device, for example an LCD display, could be integrated in the keyboard, with the assistance of which the user could carry out the configuration directly through entry at the keypad.

In addition, other association combinations are possible between the data entry modules, the encryption algorithms, and the encrypted data transmitted to the external device than are described in the exemplary embodiments in FIGS. 2 through 4. Thus, for example, the data entry modules can be placed in different classes and the encryption algorithms can be associated with the respective classes instead of individual data entry modules.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A keyboard for secure transmission of data to an external device that is connectable to the keyboard, the keyboard comprising:
at least one data entry module configured to enter data; and
a keyboard control device comprising:
at least one receiving device configured to receive the entered data;
an encryption device configured to encrypt the received data via an encryption algorithm, wherein the encryption algorithm is a program code; and
a transmission device configured to transmit the data encrypted by the encryption device to the external device connected to the keyboard control device,
wherein the encryption algorithm is selectable by the user from multiple predefined encryption algorithms and is associated with the data entry module.

2. The keyboard according to claim 1, wherein the encryption is activatable and deactivatable during operation of the keyboard.

3. The keyboard according to claim 1, wherein the keyboard control device id configured by the user via a configuration program executed on the external device.

4. The keyboard according to claim 3, wherein the encryption algorithm is selected by the user via the configuration program executed on the external device.

5. The keyboard according to claim 3, wherein, via the configuration program executed on the external device, the user:
associates a different encryption algorithm with each data entry module;
associates one and the same encryption algorithm with each data entry module; and/or
associates one and the same encryption algorithm with the entire keyboard.

6. The keyboard according to claim 3, wherein the encryption is activated and deactivated separately for each data entry module by the user via the configuration program executed on the external device.

7. The keyboard according to claim 1, wherein a key for encryption by the encryption device is:
writable in the keyboard control device by the configuration and is stored there on a long-term basis;
changeable during an operation by an application; and/or
randomly selected by the keyboard control device,
wherein an index to a known key table is transmittable,
wherein the key is a secret key or a public key, and/or
wherein a key associated with the user is entered.

8. The keyboard according to claim 1, wherein the data entry module is a keypad and/or a magnetic card reader and/or a key switch and/or a chip card reader.

9. The keyboard according to claim 1, wherein the keyboard is a POS keyboard, a bank keyboard, or a keyboard for secure data entry.

10. A method for secure transmission of data from a keyboard to an external device connectable to the keyboard, the method comprising:
entering data in at least one data entry module;
receiving the entered data by at least one receiving device of a keyboard control device;
encrypting the data received from the data entry module by an encryption device of the keyboard control device via an encryption algorithm that is selectable by a user; and
transmitting the encrypted data to the external device connected to the keyboard control device,
wherein the encryption algorithm is selectable by the user from multiple predefined encryption algorithms and is associated with the data entry module.

11. The method according to claim 10, wherein the encryption is activated and deactivated during operation of the keyboard.

12. The method according to claim 10, wherein the keyboard control device is configured by the user via a configuration program executed on the external device.

13. The method according to claim 12, wherein the encryption algorithm is selected by the user for each data entry module via the configuration program executed on the external device.

14. The method according to claim 12, wherein the keyboard control device is configured by the user via the configuration program executed on the external device such that:
the encryption is carried out with different encryption algorithms for each data entry module;
the encryption is carried out with one and the same encryption algorithm for each data entry module; or
the encryption is carried out by the encryption device with one and the same encryption algorithm for the entire keyboard.

15. The method according to claim 12, wherein the encryption is activated and deactivated separately for each data entry module by the user via the configuration program executed on the external device.

16. The method according to claim 10, wherein a key for encryption by the encryption device:
is written in the keyboard control device via a configuration and is stored there on a long-term basis;
is changed during operation by an application; and/or
is randomly selected by the keyboard control device,
wherein an index to a known key table is transmitted,
wherein the key is a secret key and a public key, and/or
wherein the key is a key associated with the user to be entered.
